(19) United States
(12) Patent Application Publication
(10) Pub. No.: US 2015/0169048 A1
(43) Pub. Date: Jun. 18, 2015

(54) SYSTEMS AND METHODS TO PRESENT INFORMATION ON DEVICE BASED ON EYE TRACKING

(71) Applicant: LENOVO (SINGAPORE) PTE. LTD., New Tech Park (SG)

(72) Inventors: Nathan J. Peterson, Durham, NC (US); John Carl Mese, Cary, NC (US); Russell Speight VanBlon, Raleigh, NC (US); Arnold S. Weksler, Raleigh, NC (US); Rod D. Waltermann, Rougemont, NC (US); Xin Feng, Arcadia, NC (US); Howard J. Locker, Cary, NC (US)

(73) Assignee: LENOVO (SINGAPORE) PTE. LTD., New Tech Park (SG)

(21) Appl. No.: 14/132,663

(22) Filed: Dec. 18, 2013

(51) Int. Cl. G06F 3/01; G06F 17/30

(52) U.S. Cl. CPC G06F 3/013; G06F 3/017; G06F 17/30247

(57) ABSTRACT

In one aspect, a device includes a display, a processor, and a memory accessible to the processor. The memory bears instructions executable by the processor to receive at least one signal from at least one camera in communication with the device, determine that a user of the device is looking at a portion of the display at least partially based on the signal, and present information associated with an item presented on the portion in response to the determination that the user is looking at the portion.

### I. FIELD

The present application relates generally to using eye tracking to present information on a device.

### II. BACKGROUND

Currently, in order to have information be presented on a device that is related to e.g. an icon or image presented thereon, a user typically must take a series of actions to cause the information to be presented. This is not intuitive and can indeed be laborious.

### SUMMARY

Accordingly, in a first aspect a device includes a display, a processor, and a memory accessible to the processor. The memory bears instructions executable by the processor to receive at least one signal from at least one camera in communication with the device, determine that a user of the device is looking at a portion of the display at least partially based on the signal, and present information associated with an item presented on the portion in response to the determination that the user is looking at the portion.

In another aspect, a method includes receiving data from a camera at a device, determining that a user of the device is looking at a particular area of a display of the device for at least a threshold time at least partially based on the data, and presenting metadata associated with a feature presented on the area in response to determining that the user is looking at the area for the threshold time.

In still another aspect, an apparatus includes a first processor, a network adapter, and storage bearing instructions for execution by a second processor for presenting a first image on a display, receiving at least one signal from at least one camera in communication with a device associated with the second processor, and determining that a user of the device is looking at a portion of the first image for at least a threshold time at least partially based on the signal. The instructions for execution by the second processor also include determining that an image of a person in is the portion of the first image in response to the determination that the user is looking at the portion for the threshold time, extracting data from the first image that pertains to the person, executing a search for information on the person using at least a portion of the data, and presenting the information on at least a portion of the display. The first processor transfers the instructions over a network via the network adapter to the device.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of a system in accordance with present principles;

FIGS. 2 and 3 are exemplary flowcharts of logic to be executed by a system in accordance with present principles;

FIGS. 4-8 are exemplary illustrations of present principles; and

FIG. 9 is an exemplary settings user interface (UI) presentable on a system in accordance with present principles.

### DETAILED DESCRIPTION

This disclosure relates generally to (e.g. consumer electronics (CE)) device based user information. With respect to any computer systems discussed herein, a system may include server and client components, connected over a network such that data may be exchanged between the client and server components. The client components may include one or more computing devices including televisions (e.g. smart TVs, Internet-enabled TVs), computers such as laptops and tablet computers, and other mobile devices including smart phones. These client devices may employ, as non-limiting examples, operating systems from Apple, Google, or Microsoft. A Unix operating system may be used. These operating systems can execute one or more browsers such as a browser made by Microsoft or Google or Mozilla or other browser program that can access web applications hosted by the Internet servers over a network such as the Internet, a local intranet, or a virtual private network.

As used herein, instructions refer to computer-implemented steps for processing information in the system. Instructions can be implemented in software, firmware or hardware; hence, illustrative components, blocks, modules, circuits, and steps are set forth in terms of their functionality.

A processor may be any conventional general purpose single- or multi-chip processor that can execute logic by means of various lines such as address lines, data lines, and control lines and registers and shift registers. Moreover, any logical blocks, modules, and circuits described herein can be implemented or performed, in addition to a general purpose processor, in or by a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

Any software and/or applications described by way of flow charts and/or user interfaces herein can include various sub-routines, procedures, etc. It is to be understood that logic divulged as being executed by e.g. a module can be redistributed to other software modules and/or combined together in a single module and/or made available in a shareable library.

Logic when implemented in software, can be written in an appropriate language such as but not limited to C# or C++, and can be stored on or transmitted through a computer-readable storage medium (e.g. that may not be a carrier wave) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and twisted pair wires. Such connections may include wireless communication connections including infrared and radio.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” is used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

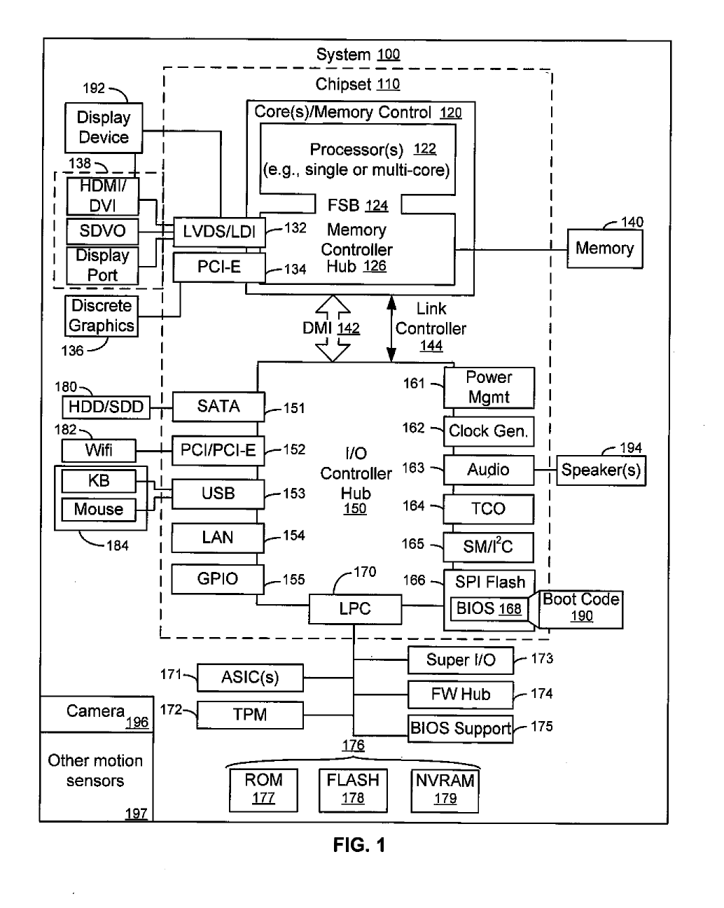

Now specifically in reference to FIG. 1, it shows an exemplary block diagram of a computer system 100 such as e.g. an Internet enabled, computerized telephone (e.g. a smart phone), a tablet computer, a notebook or desktop computer, an Internet enabled computerized wearable device such as a smart watch, a computerized television (TV) such as a smart TV, etc. Thus, in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100.

As shown in FIG. 1, the system 100 includes a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the conventional“northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 further includes a low-voltage differential signaling interface (LVDS) 132. The LVDS 132 may be a so-called LVDS Display Interface (LDI) for support of a display device 192 (e.g., a CRT, a flat panel, a projector, a touch-enabled display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (×16) PCI-E port for an external PCI-E-based graphics card (including e.g. one of more GPUs). An exemplary system may include AGP or PCI-E for support of graphics.

The I/O hub controller 150 includes a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 provide for communication with various devices, networks, etc. For example, the SATA interface 151 provides for reading, writing or reading and writing information on one or more drives 180 such as HDDs, SDDs or a combination thereof, but in any case the drives 180 are understood to be e.g. tangible computer readable storage mediums that may not be carrier waves. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Further still, in some embodiments the system 100 may include one or more cameras 196 providing input to the processor 122. The camera 196 may be, e.g., a thermal imaging camera, a digital camera such as a webcam, and/or a camera integrated into the system 100 and controllable by the processor 122 to gather pictures, images, and/or video in accordance with present principles (e.g. to gather one or more images of a user and/or track the user's eye movements, etc.). Also, the system 100 may include one or more motion sensors 197 (e.g., a gesture sensor for sensing a gesture and/or gesture command) providing input to the processor 122 in accordance with present principles.

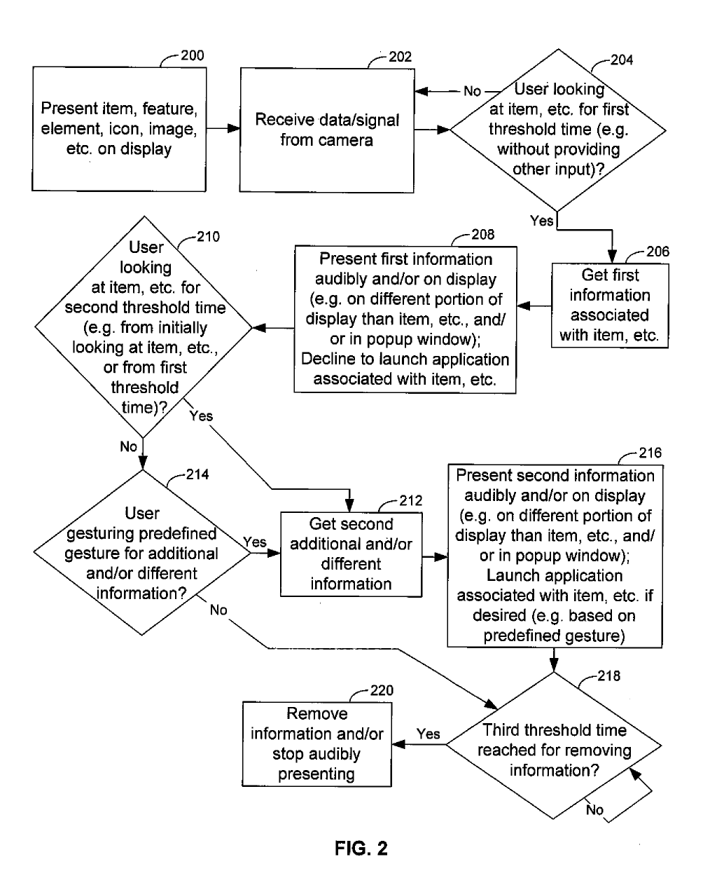

Before moving on to FIG. 2 and as described herein, it is to be understood that the systems and devices in accordance with present principles may include fewer or more features than shown on the system 100 of FIG. 1. In any case, it is to be understood at least based on the foregoing that the system 100 is configured to undertake present principles.

Now in reference to FIG. 2, an example flowchart of logic to be executed by a device such as the system 100 is shown. Beginning at block 200, the logic presents at least one item (e.g. a file, calendar entry, scrolling news feed, contact from a user's contact list etc.), icon (e.g. a shortcut icon to launch a software application), feature (e.g. software feature), element (e.g. selector elements, tiles (e.g. in a tablet environment), image (e.g. a photograph), etc. on a display of the device undertaking the logic of FIG. 2. For brevity, the item, icon, feature, element, image, etc. will be referred to below as the “item, etc.” The logic then proceeds to block 202 where the logic receives at least one signal, and/or receives image data, from at least one camera in communication with the device that e.g. pertains to the user (e.g. the user's face and/or eye movement). The logic then proceeds to decision diamond 204 where the logic determines whether the user is looking at a portion and/or area of the display including the item, etc. (e.g. within a threshold (e.g. display) distance of the object) for at least a first threshold time (e.g. without also providing additional input through manipulation of a keyboard, mouse, etc. in communication with the device). Note that in some embodiments, at diamond 204 the logic may determine not only that the user is looking at the portion and/or area, but that the user is specifically looking at or at lest proximate to the item.

In any case, a negative determination at diamond 204 causes the logic to revert back to block 202 and proceed therefrom. However, an affirmative determination at diamond 204 causes the logic to proceed to block 206 where the logic locates and/or accesses first information associated with the item, etc. that may be e.g. metadata locally stored on a storage medium of the device undertaking the logic of FIG. 2, may be information gathered over the Internet by accessing a website associated with the item, etc. (e.g. a company website for a company that provides software associated with an icon presented on the display), information provided by and/or input to the device by a user regarding the item at a time prior to the undertaking of the logic of FIG. 2, etc.

After block 206 the logic proceeds to block 208 where the logic in response to the determination that the user is looking at the portion, and/or item, etc. specifically, presents the first information to the user. The first information may be presented e.g. audibly (over speakers on and/or in communication with the device) and/or visually (e.g. on the device's display). Moreover, the first information in some embodiments may be presented over the item, etc., while in other embodiments may be presented on a portion of the display other than on which the item, etc. is presented. In still other embodiments, the first information may be presented e.g. over at least a portion of the display on which the item, etc. is presented and over another portion. Regardless, also note that the first information may be presented in an overlay window and/or pop-up window.

Still in reference to block 208, note that also thereat, the logic may decline to launch a software application associated with the item (and/or decline to execute another function of the software application if e.g. already launched), etc, looked at by the user such as when e.g. the item, etc. is a shortcut icon for which input has been detected by way of the user's eyes looking at the item. In this example, when the logic may have thus determined that the user is looking at the icon, thereby providing input to the device pertaining to the icon, but the underlying software application associated therewith will not be launched. Rather, the logic may gather metadata associated with the icon and present it in a pop-upon window next to the icon being looked at.

Still in reference to FIG. 2, after block 208 the logic proceeds to decision diamond 210. At decision diamond 210, the logic determines whether the user is looking (e.g. continues to look without diverting their eyes to another portion of the display from when the affirmative determination was made at diamond 204) at the portion and/or specifically the item, etc. (e.g. within a threshold (e.g. display) distance of the object) for at least a second threshold time (e.g. without also providing additional input through manipulation of a keyboard, mouse, etc. in communication with the device). Describing the second threshold time, in some embodiments it may be the same length of time as the first threshold time, while in other embodiments may be a different length of time. Furthermore, the logic may determine whether the user use is looking at the item, etc. for the second threshold time when e.g. the second threshold time begins from when the logic determined the user initially looked at the item, etc. even if prior to the expiration of the first threshold time. However, in other embodiments the second threshold time may begin from when the logic determines at diamond 204 that the user is looking at least substantially at the item for the first threshold time.

Still in reference to diamond 210, an affirmative determination thereat causes the logic to proceed to block 212, which will be described shortly. However, a negative determination at diamond 210 causes the logic to proceed to decision diamond 214. At decision diamond 214, the logic determines whether the user is gesturing a (e.g. predefined) gesture recognizable, discernable, and/or detectable by the device based on e.g. input from the camera and/or from a motion sensor such as the sensor 197 described above.

A negative determination at diamond 214 causes the logic to proceed to decision diamond 218, which will be described shortly. However, an affirmative determination at diamond 214 causes the logic to proceed to block 212. At block 212, the logic locates and/or accesses second information associated with the item, etc. that may be e.g. additionally metadata locally stored on a storage medium of the device undertaking the logic of FIG. 2, may be additional information gathered over the Internet by accessing a website associated with the item, etc., may be additional information provided to the device by a user regarding the item at a time prior to the undertaking of the logic of FIG. 2, etc. Thus, it is to be understood that the second information may be different than the first information, and/or may include at least some of the first information and still additional information.

From block 212 the logic proceeds to block 216 where the logic in response to the determination that the user is looking at the portion, and/or item, etc. specifically for the second threshold time, presents the second information to the user. The second information may be presented e.g. audibly (over speakers on and/or in communication with the device) and/or visually (e.g. on the device's display). Moreover, the second information in some embodiments may be presented over the item, etc., while in other embodiments may be presented on a portion of the display other than on which the item, etc. is presented. In still other embodiments, the second information may be presented e.g. over at least a portion of the display on which the item, etc. is presented and over another portion. Regardless, also note that the second information may be presented in an overlay window and/or pop-up window.

Still in reference to block 216, note that also thereat, the logic may launch a software application associated with the item, etc. looked at by the user (and/or execute another function of the software application if e.g. already launched) such as when a gesture determined to be gestured by the user at diamond 214 is detected and is associated with launching a software application, and/or the software application that is being looked at in particular.

After block 216, the logic proceeds to decision diamond 218. At diamond 218, the logic determines whether a third threshold time has been reached and/or lapsed, where the third threshold time pertains to whether the first and/or second information should be removed. In some embodiments, the third threshold time may be the same length of time as the first and second threshold times, while in other embodiments may be a different length of time than one or both of the first and second threshold times. Furthermore, the logic may determine whether the user use is looking at the item, etc. for the third threshold time when e.g. the third threshold time begins from when the logic determined the user initially looked at the item, etc. even if prior to the expiration of the first and/or second threshold times. However, in other embodiments the third threshold time may begin from when the logic determines at diamond 204 that the user is looking at least substantially at the item, etc. for the first threshold time, and/or from when the logic determines at diamond 210 that the user is looking at least substantially at the item, etc. for the second threshold time.

In any case, a negative determination at diamond 218 may cause the logic to continue making the determination thereat until such time as an affirmative determination is made. Upon an affirmative determination at diamond 218, the logic proceeds to block 220. At block 220, the logic removes the first and/or second information from display if presented thereon, and/or ceases audibly presenting it.

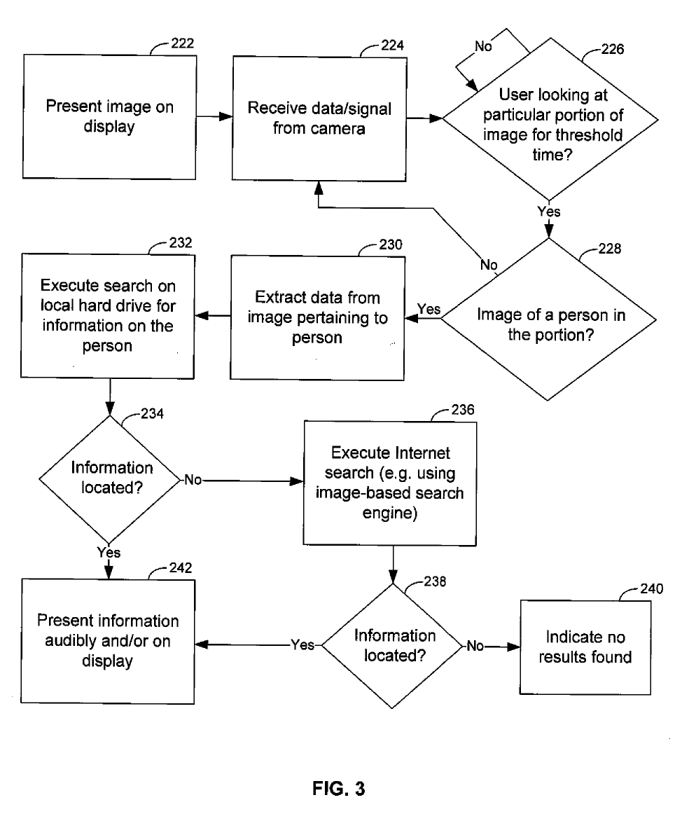

Continuing the detailed description in reference to FIG. 3, it shows logic that may be used in conjunction with and/or incorporated into the logic of FIG. 2, and/or may be independently undertaken. Regardless, at block 222 the logic presents an image in accordance with present principles on a display of the device undertaking the logic of FIG. 3. Then at block 224 the logic receives at least one signal and/or receives data from at least one camera in communication with the device pertaining to e.g. the user's eye movement and/or the user's gaze being directed to the image. The logic then proceeds to decision diamond 226 where the logic determines at least partially based on the signal whether the user is looking at a specific and/or particular portion of the first image for at least a threshold time (e.g. continuously without the user's eyes diverting to another portion of the image and/or elsewhere). A negative determination at diamond 226 causes the logic to continue making the determination thereat until an affirmative determination is made.

Once an affirmative determination is made at diamond 226, the logic proceeds to decision diamond 228. At diamond 228, the logic determines whether an image of a person in is the portion of the image, and may even determine e.g. whether the portion includes an image of a face in particular. A negative determination at diamond 228 causes the logic to revert back to block 224 and proceed therefrom. An affirmative determination at diamond 228 causes the logic to proceed to block 230 where the logic extracts data from the image pertaining to the person in the portion (e.g., object extractions recognizing the image within the image itself). Also at block 230, the logic may e.g. green or gray the portion of the image being looked at to convey to the user that the device has detected the user's eye attention as being directed thereat and that the device is accordingly in the process of acquiring information about what is shown in that portion. The logic then proceeds to block 232 where the logic executes, using at least a portion of the data that was extracted at block 230, a search for information on the person locally on the device by e.g. searching for information on the person stored on a computer readable storage medium on the device. For instance, a user's contact list may be accessed to search using facial recognition for an image in the contact list matching the image of the person for which the user's attention has been directed for the threshold time to thus identify a person in the contact list and provide information about that person. Notwithstanding, note that both local and information acquired from remote sources may be used such as e.g. searching a user's contact list, and/or searching using a person's locally stored login information a social networking account to determine friends of the user having a face matching the extracted data.

From block 232 the logic proceeds to decision diamond 234 where the logic determines whether at least some information on the person has been located based on the local search. An affirmative determination at diamond 234 causes the logic to proceed to block 242, which will be described shortly. A negative determination at diamond 234, however, causes the logic to proceed to block 236.

At block 236, the logic executes, using at least a portion of the data that was extracted at block 230, an Internet search for information on the person by e.g. using a search engine such as an image-based Internet search engine and/or a facial recognition search engine. The logic then proceeds to decision diamond 238. At diamond 238, the logic determines whether at least some information on the person from the portion of the image has been located based on e.g. the Internet search. An affirmative determination at diamond 238 causes the logic to proceed to block 242, where the logic presents at least a portion of the information that has been located. However, a negative determination at diamond 238 causes the logic to proceed to block 240 where the logic may indicate e.g. audibly and/or on the device's display that no information could be located for the person in the portion of the image being looked at for the threshold time.

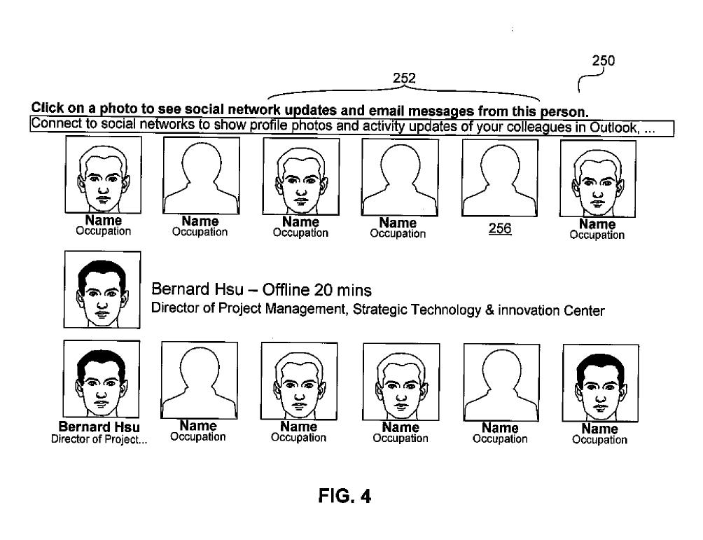

Before moving on to FIG. 4, it is to be understood that while in the exemplary logic shown in FIG. 3 the logic executes the Internet search responsive to determining that information stored locally on the device could not be located, in some embodiments both a local and Internet search may be performed regardless of e.g. information being located from one source prior to searching the other. Thus, in some embodiments at block 242, the logic may present information from both searches.

Now in reference to FIG. 4, it shows an example illustration 250 of items, etc. and information related thereto presented on a display in accordance with present principles. It is to be understood that what is shown in FIG. 4 may be presented e.g. upon a device in accordance with present principles detecting that a user is looking at a particular item, etc. for at least one threshold time as described herein. The illustration 250 shows a display and/or a user interface (UI) presentable thereon that includes plural contact items 252 for contacts of the user accessible to and/or stored on the device. The contact items 252 thus include a contact item 254 for a particular person, it being understood that the item 254 is the item looked at by the user for the threshold time as detected at least in part using a camera of the device. Thus, an overlay window 256 has been presented responsive to the user looking at the contact item 254 for the threshold time and includes at least some information and/or metadata in the window 256 in addition to any information that may already have been presented pertaining to the contact item 254.

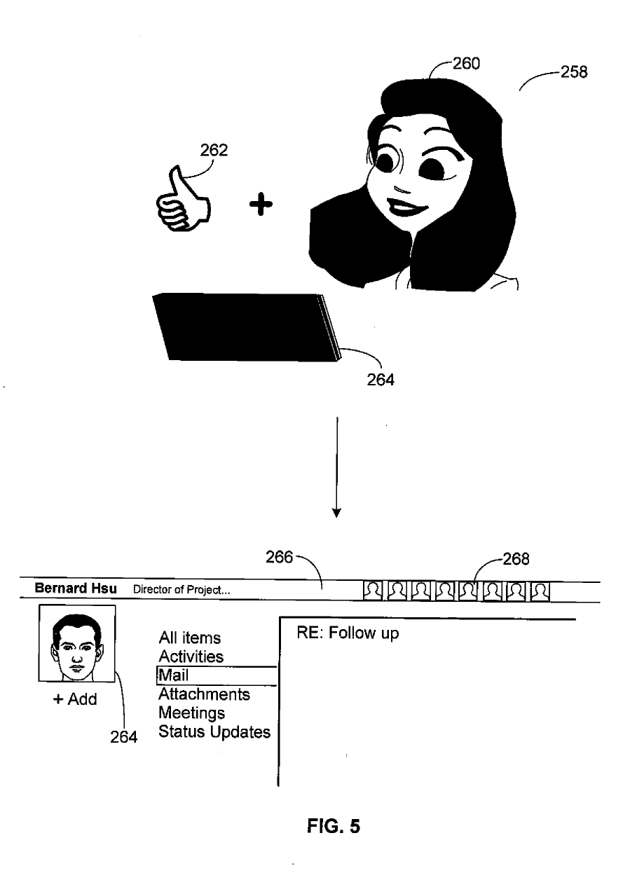

Reference is now made to FIG. 5, which shows an exemplary illustration 258 of a person 260 gesturing a thumbs up gesture in free space that is detectable by a device 264 such as the system 100. As shown in the illustration 258, information 266 (e.g. second information in accordance with FIG. 2 in some embodiments) is presented on a display 268 of the device 264 in accordance with present principles (e.g. responsive to a threshold time being reached while the user continuously looks at the item 254). Thus, it is to be understood that e.g. what is shown in FIG. 4 may be presented responsive to the first threshold discussed in reference to FIG. 2 being reached, while what is shown in FIG. 5 may be presented responsive to the second threshold discussed in reference to FIG. 2 being reached.

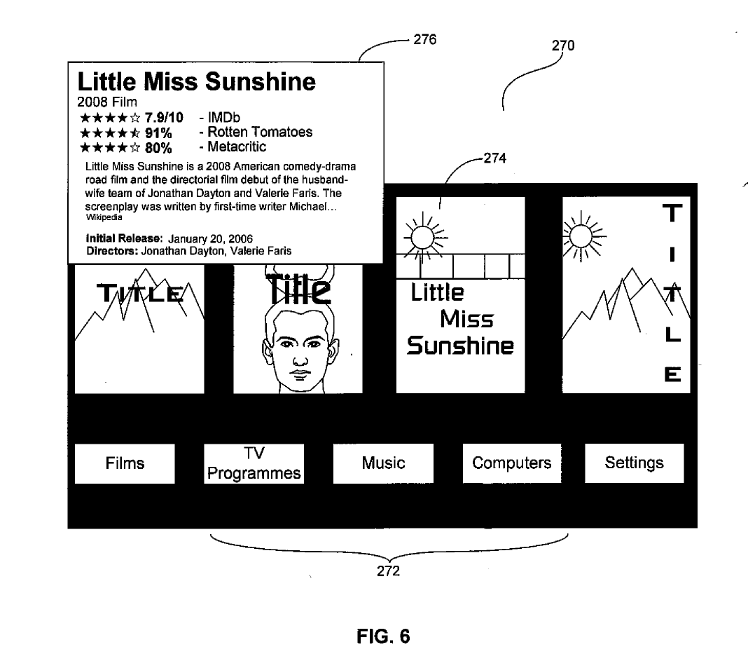

Continuing the detailed description in reference to FIG. 6, it shows yet an example illustration 270, this one pertaining to audio video-related (AV) items, etc. and information related thereto as presented on a display in accordance with present principles. It is to be understood that what is shown in FIG. 6 may be presented e.g. upon a device in accordance with present principles detecting that a user is looking at a particular item, etc. for at least one threshold time as described herein.

The illustration 270 shows a display and/or a user interface (UI) presentable thereon that includes plural AV items 272 for AV content, video content, and/or audio content accessible to and/or stored on the device. Thus, it is to be understood that in some embodiments, the UI shown may be an electronic programming guide. In any case, the items 272 may include a motion picture item 274 for a particular motion picture, it being understood that the item 274 is the item looked at by the user for the threshold time as detected at least in part using a camera of the device. Thus, an overlay window 276 has been presented responsive to the user looking at the item 274 for a threshold time and includes at least some information and/or metadata in the window 276 in accordance with present principles. As shown, the window 276 includes the title of the motion picture, as well as its release information, ratings, a plot synopsis, and a listing of individuals involved in its making.

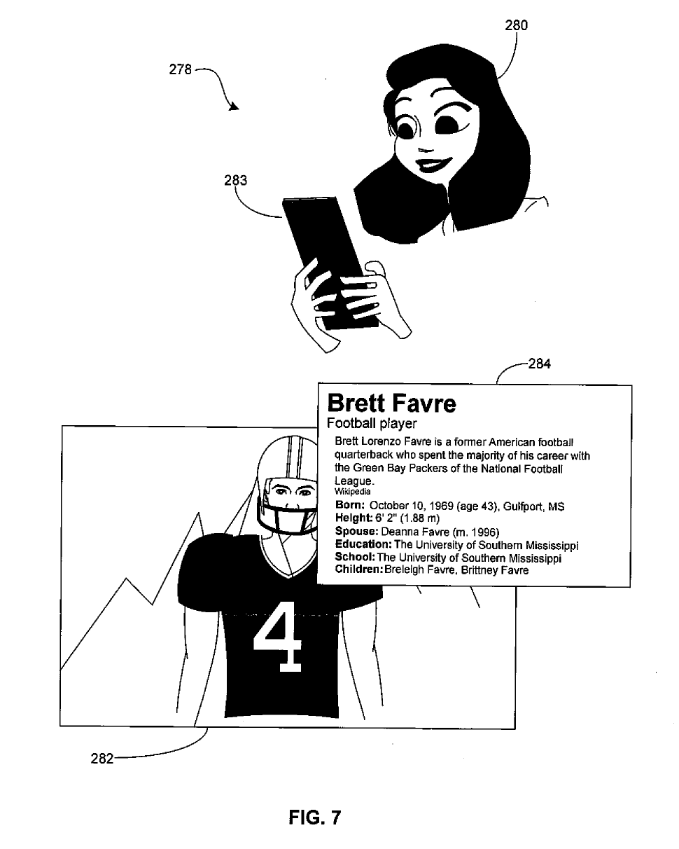

Turning to FIG. 7, it shows yet an example illustration 278 of a person 280 looking at an image 282 on a device 283 such as the system 100 described above in accordance with present principles. It is to be understood that what is shown in FIG. 7 may be presented e.g. upon a device detecting that a user is looking at a portion of the image 282, which in this case is Brett Favre's face as represented in the image, for at least one threshold time as described herein. An overlay window 284 has been presented responsive to the user looking at least a portion of Brett Favre's face for a threshold time, and includes at least some information and/or metadata in the window 284 (e.g. generally) related to Brett Favre in accordance with present principles. As shown, the window 284 includes an indication of what Brett Favre does for a living (e.g. play football), indicates his full birth name and information about his football career, as well as his birthdate, height, spouse, education and/or school, and his children. It is to be understood that the information shown in the window 284 may be information e.g. accessed over the Internet by extracting data from the portion of the image containing Brett Favre's face and then using the data to perform a search on information related to Brett Favre using an image-based Internet search engine.

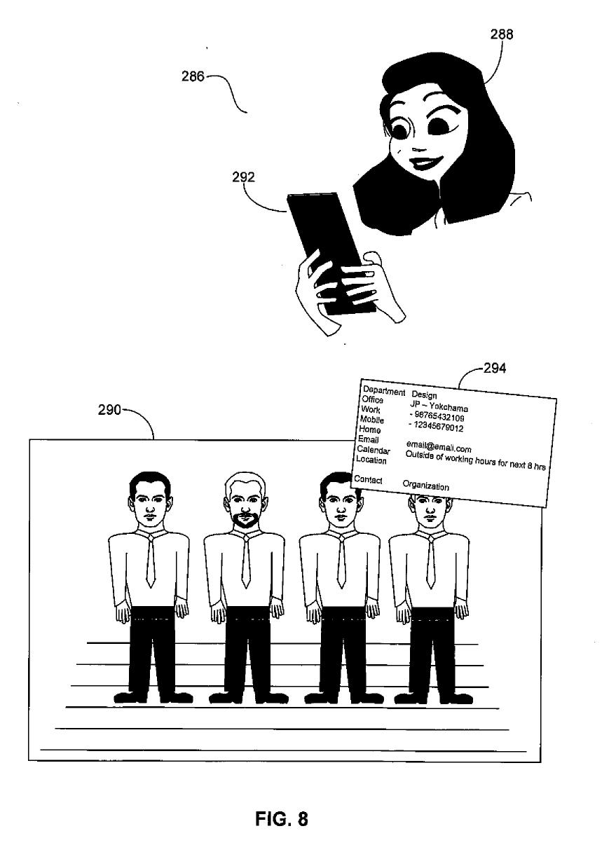

Now in reference to FIG. 8, it shows yet an example illustration 286 of a person 288 looking at an image 290 on a device 292 such as the system 100 described above in accordance with present principles. It is to be understood that what is shown in FIG. 8 may be presented e.g. upon a device detecting that a user is looking at a portion of the image 290, which in this case is a particular person in a group photograph, for at least one threshold time as described herein. An overlay window 294 has been presented responsive to the user looking at least a portion of the particular person for a threshold time, and includes at least some information and/or metadata in the window 294 related to the person in accordance with present principles. As shown, the window 294 includes an indication of what company department the person works in, what office location they work at, what their contact information is, and what their calendar indicates they are currently and/or will be doing in the near future.

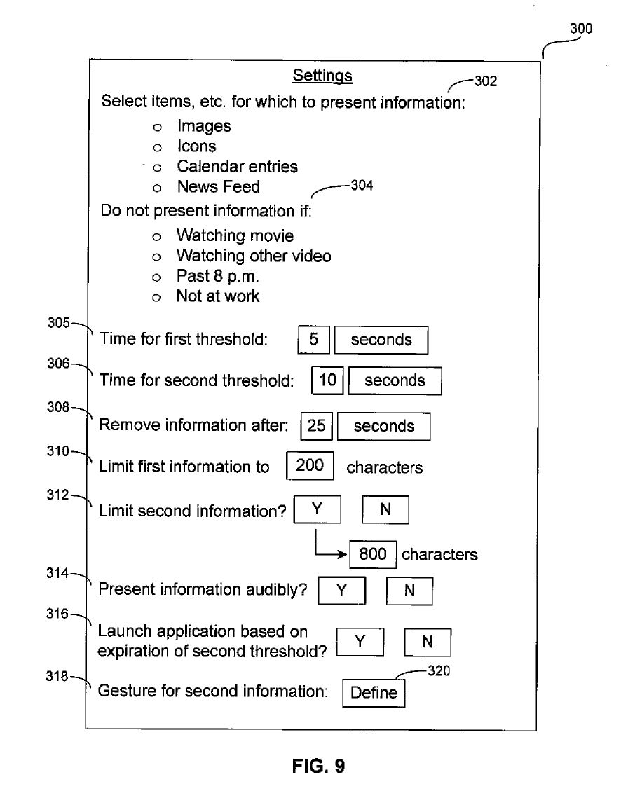

Moving on in the detailed description with reference to FIG. 9, it shows an exemplary settings user interface (UI) presentable on a device in accordance with present principles such as the system 100 to configure settings associated with detecting a user's eye gaze and presenting information responsive thereto as set forth herein. The UI 300 includes a first setting 302 for a user to provide input (e.g. using radio buttons as shown) for selecting one or more types of items for which to present information e.g. after looking at the item for a threshold time (e.g. rather than always and everywhere presenting information when a user looks at a portion of the display, which may be distracting when e.g. watching a full-length movie on the device). Thus, a second setting 304 is also shown for configuring the device to specifically not present information in some instances even when e.g. a user's gaze may be detected as looking at a portion/item for a threshold time as set forth herein.

Yet another setting 305 is shown for a user to define a time length for a first threshold time as described herein, along with an input box and time unit box for inputting the particular time desired (e.g. in this instance, five seconds). Note that the time unit of seconds may not be the only time unit that may be input by a user, and may be e.g. minutes or hours as well. In any case, a setting 306 is shown for a user to define a time length for a second threshold time as described herein, along with an input box and time unit box for inputting the particular time desired (e.g. in this instance, ten seconds). Yet another setting 308 is shown for a user to define a time length for a third threshold time as described herein to remove information that may have been presented, along with an input box and time unit box for inputting the particular time desired (e.g. in this instance, twenty five seconds).

The settings UI 300 may also include a setting 310 for a user to provide input to limit the amount of first information presented responsive to the user looking at an item for a first threshold time as described above (e.g. in reference to FIG. 2), in this case two hundred characters as input to an input box as shown. A setting 312 is shown for a user to provide input for whether to limit the amount of second information presented responsive to the user looking at an item for a second threshold time as described above (e.g. in reference to FIG. 2), if desired. Thus, yes and no selector elements are shown for setting 312 that are selectable to configure or not configure, respectively, the device to limit the amount of second information presented. An input box for the setting 312 is also shown for limiting the second information to a particular number of characters, in this case e.g. eight hundred characters.

In addition to the foregoing, the UI 300 includes a setting 314 for configuring the device to present or not present the first and/or second information audibly based on respective selection of the yes or no selector elements shown for the setting 314. Note that although only one setting for audibly presenting information is shown, separate settings may be configured for the first and second information (e.g. not audibly presenting the first information but audibly presenting the second information).

Also shown is a setting 316 for, based on respective selection of yes or no selector elements for the setting 316 as shown, whether to launch an application that may be associated with an item being looked at upon expiration of a second threshold time as described herein. Yet another setting 318 is shown for configuring the device to receive, recognize, and/or associate one or more predefined gestures for purposes disclosed herein. Thus, a define selector element 320 is shown that may be selectable to e.g. input to the device and define one or more gestures according to user preference (e.g. by presenting a series of configuration prompts for configuring the device to recognize gestures as being input for present purposes).

Without reference to any particular figure, it is to be understood that an on-screen cursor may be presented in accordance with present principles. For instance, as the device tracks the user's eyes as the user's attention transverses various parts of the display, the device's cursor (e.g. that may also be manipulated by manipulating a mouse in communication with the device) may move to positions corresponding to the user's attention location at any particular moment. Notwithstanding, the cursor may “skip” or “jump” from one place to another as well based on where the user's attention is directed. For instance, should the user look at the top right corner of the display screen but the cursor be at the bottom left corner, the cursor may remain thereat until e.g. the first threshold time described above has been reached, at which point the cursor may automatically without further user input cease to appear in the bottom left corner and instead appear in the top right corner at or at least proximate to where the user's attention is directed.

Also without reference to any particular figure, it is to be understood that in some embodiments, the first information described above in reference to FIG. 2 may be e.g. the same type of information as may be presented responsive to e.g. a right click using a mouse on whatever the item may be, and/or a hover of the cursor over the item. It is to also be understood that in some embodiments, the second information described above in reference to FIG. 2 may be e.g. the same type of information as may be presented responsive to e.g. a left click using a mouse on whatever the item may be.

Not further that while time thresholds have been described above for determinations regarding whether to present the first and second information and/or image information, still other ways of making such determinations may be taken in accordance with present principles. For instance, eye tracking software may be used in accordance with present principles to make such determinations based on eye kinematics, including acceleration to or away from an object above or below an acceleration threshold, deceleration to an object above or below an acceleration threshold, jerk recognition and thresholds, and speed and/or velocity recognition and thresholds.

Moreover, present principles recognize that a user's attention directed to a particular item, etc. may not necessarily be entirely immobile for the entire time until reaching the first and second threshold. In such instances, a determination such as that made at decision diamonds 204, 210, and 226 may be determinations that e.g. the user's eye(s) moves less than a threshold amount and/or threshold distance (e.g. from the initial eye position directed to the item, etc.) for the respective threshold time.

Thus, in some embodiments the movement-oriented eye data may be used to determine eye movement and/or position values, which may then be compared to a plurality of thresholds to interpret a user's intention (e.g. whether the user is continuing to look at an item on the display or has diverted their attention elsewhere on the display). For example, where an acceleration threshold is exceeded by the user's eyes and a jerk (also known as jolt) threshold is exceeded, it may be determined that a user's eye movement indicates a distraction movement where the user diverts attention away from the object being looked at. Also in some embodiments, the movement and/or position values may be compared to a plurality of (e.g. user) profiles to interpret a user's intention. For example, where velocity values match a bell curve, a user's eye movement may be interpreted as a short range movement to thus determine that the user is still intending to look at a particular object presented on the screen that was looked at before the eye movement. In some embodiments, the movement and/or position values may be compared to thresholds and profiles to interpret a user's intention. For example, where velocity values match a bell curve and an acceleration value exceeds a threshold, a user's movement may be interpreted as a long-range movement (e.g. away from the item being looked at).

Moreover, a device in accordance with present principles may limit the number of biometric data values to a predefined “window” size, where the window size corresponds to a user reaction time. Using a window size above a user's reaction time can improve reliability as it ensures that the detected movement is a conscious movement (i.e., a reaction diverting attention away from an object being looked at) and not an artifact or false positive due to noise, involuntary movements, etc. where the user e.g. still intends to be looking at the object (e.g. for at threshold time).

It is to be further understood that a device in accordance with present principles may determine movement values (e.g. acceleration) values from eye-movement-oriented data. For example, where eye data comprises position values and time values, the device may derive acceleration values corresponding to the time values. In some embodiments, the device may determine position, velocity, and/or jerk values from the eye data. The device may include circuitry for calculating integrals and/or derivatives to obtain movement values from the eye data. For example, the device may include circuitry for calculating second-derivatives of location data.

The device may thus interpret a user intention for a movement based on the movement values that have been determined. For example, the device may determine if the user intends to perform a short-range action (e.g. while still looking at the same item as before presented on the display) or a long-range action (e.g. looking away from an item presented on the display). In some embodiments, acceleration, velocity, position, and/or jerk values may be compared to a threshold and/or profile to interpret the user intention. For example, the device may determine that a user intended to make a short-range movement where velocity values match a bell curve profile. In some embodiments, movement values (e.g., acceleration, velocity, position, and/or jerk values) may be compared to a combination of thresholds and profiles to interpret a user's intention. For example, where velocity values match a bell curve and an acceleration value exceeds a threshold, a user's movement may be interpreted as a long-range movement (e.g. away from an object being looked at).

Thus, it is to be understood that in some embodiments, the device may store one or more position profiles for categorizing user movements. For example, the device may store a position profile corresponding to a short-range movement within the display of the device.

Furthermore, the movement values may be (e.g. initially) examined in accordance with present principles based on determining whether one or more triggers have been met. The triggers may be based on e.g. position, velocity, and/or acceleration and indicate to the device that a movement in need of interpretation has occurred (e.g. whether a detected eye movement indicates the user is looking away from a looked-at item or continues to look at it even given the eye movement). Once the trigger(s) is met, the movement values may be interpreted to determine a use's intention.

Before concluding, also note that e.g. although FIG. 3 and some of the illustrations discussed herein involve determining whether a person is in a particular area of an image, the same principles and/or determinations and other logic steps apply mutatis mutandis to objects in a particular portion of an image other than people and/or faces. For instance, responsive to the device determining that a user is looking at a particular area of an image, the logic may determine the user is looking at a particular object contained therein, extract data about the object, and perform a search using the extracted data to return information about the object.

It may now be appreciated based on present principles that a an item of interest to a user may be detected using eye tracking software to thus provide information about that item or an underlying feature associated therewith. For example, a user focusing on a particular day on a calendar may cause details about that day to be presented such as e.g. birthday, anniversaries, appointments, etc. as noted in the calendar. As another example, looking at a file or photo for a threshold time may cause additional details about the item to be presented such as e.g. photo data and/or location, settings, etc. As yet another example, looking at a live tile or news feed scroll for a threshold time may cause more detail regarding the article or news to be presented, including e.g. excerpts from the article itself.

Present principles also recognize that e.g. the logic steps described above may be undertaken for touch-screen devices and non-touch-screen devices.

Present principles further recognize that although e.g. a software application for undertaking present principles may be vended with a device such as the system 100, it is to be understood that present principles apply in instances where such an application is e.g. downloaded from a server to a device over a network such as the Internet.

While the particular SYSTEMS AND METHODS TO PRESENT INFORMATION ON DEVICE BASED ON EYE TRACKING is herein shown and described in detail, it is to be understood that the subject matter which is encompassed by the present application is limited only by the claims.

What is claimed is:

1. A device, comprising:
a display;
a processor;
a memory accessible to the processor and bearing instructions executable by the processor to:
receive at least one signal from at least one camera in communication with the device;
at least partially based on the signal, determine that a user of the device is looking at a portion of the display; and
in response to the determination that the user is looking at the portion, present information associated with an item presented on the portion.

2. The device of claim 1, wherein the information is presented in response to a determination that the user is looking at least substantially at the item for a threshold time.

3. The device of claim 2, wherein the information is first information and the threshold time is a first threshold time, and wherein the instructions are further executable by the processor to:
determine that the user is looking at least substantially at the item for a second threshold time; and
present second information associated with the item in response to the determination that the user is looking at least substantially at the item for the second threshold time, the second information being different than the first information.

4. The device of claim 2, wherein the information is first information and the threshold time is a first threshold time, and wherein the instructions are further executable by the processor to:
determine that the user is looking at least substantially at the item for a second threshold time; and
present second information associated with the item in response to the determination that the user is looking at least substantially at the item for the second threshold time, the second information including the first information and additional information associated with the item.

5. The device of claim 2, wherein the information is first information and the threshold time is a first threshold time, and wherein the instructions are further executable by the processor to:
determine that the user is looking at least substantially at the item for a second threshold time, the determination that the user is looking at least substantially at the item for the second threshold time being a determination subsequent to the determination that the user is looking at the portion for the first threshold time, the second threshold time being different in length than the first threshold time; and
present second information associated with the item in response to the determination that the user is looking at least substantially at the item for the second threshold time.

6. The device of claim 2, wherein the information is first information and the threshold time is a first threshold time, and wherein the instructions are further executable by the processor to:
determine that the user is gesturing a predefined gesture; and
present second information associated with the item in response to the determination the user is gesturing the predefined gesture, the second information being different than the first information.

7. The device of claim 5, wherein the second threshold time begins from when the processor determines the user initially looks at least substantially at the item.

8. The device of claim 5, wherein the second threshold time begins from when the processor determines the user is looking at least substantially at the item for the first threshold time.

9. The device of claim 1, wherein the portion is a first portion and the information is presented on the display, and wherein the information is presented on a second portion of the display not including the first portion.

10. The device of claim 9, wherein the information is presented in a window on the second portion.

11. The device of claim 9, wherein the information is presented in response to a determination that the user is looking at least substantially at the item for a first threshold time, and wherein the instructions are further executable by the processor to remove the information from the second portion of the display after a second threshold time.

12. The device of claim 1, wherein the information is presented at least audibly to the user over a speaker in communication with the device.

13. The device of claim 1, wherein the information is presented without launching a software application associated with the item.

14. The device of claim 1, wherein the information is presented on the portion without user input other than the user looking at the portion.

15. A method, comprising:
receiving data from a camera at a device;
at least partially based on the data, determining that a user of the device is looking at a particular area of a display of the device for at least a threshold time; and
in response to determining that the user is looking at the area for the threshold time, presenting metadata associated with a feature presented on the area.

16. The method of claim 15, wherein the metadata is first metadata and the threshold time is a first threshold time, and wherein the method further includes:
presenting second metadata associated with the feature, the second metadata not being identical to the first metadata, the second metadata being presented in response to determining the user is engaging in an action selected from the group consisting of: looking at the particular area for a second threshold time, and gesturing a predefined gesture.

17. The method of claim 15, wherein the metadata is presented without launching a software application associated with the feature.

18. An apparatus, comprising:
a first processor;
a network adapter;
storage bearing instructions for execution by a second processor for:
presenting a first image on a display;
receiving at least one signal from at least one camera in communication with a device, the device associated with the second processor;
at least partially based on the signal, determining that a user of the device is looking at a portion of the first image for at least a threshold time;
in response to the determination that the user is looking at the portion for the threshold time, determining that an image of a person in is the portion of the first image;
extracting data from the first image that pertains to the person;
executing, using at least a portion of the data, a search for information on the person; and
presenting the information on at least a portion of the display;
wherein the first processor transfers the instructions over a network via the network adapter to the device.

19. The apparatus of claim 18, wherein the search is executed using an image-based Internet search engine.

20. The apparatus of claim 18, wherein the search is a search for the information on a computer readable storage medium on the device.
